(19) United States
(12) Patent Application Publication
(10) Pub. No.: US 2009/0245974 A1
(43) Pub. Date: Oct. 1, 2009

(54) Plate-shaped fastener device

(76) Inventor: Chun I Yao, Taichung (TW)

Correspondence Address: CHARLES E. BAXLEY, ESQUIRE, 90 JOHN STREET, SUITE 309, NEW YORK, NY, 10038, US

(21) Appl. No.: 12/079,190

(22) Filed: Mar. 25, 2008

(51) Int. Cl. F16B 15/00

(52) U.S. Cl. 411/478; 411/488

(57) ABSTRACT

A fastener device includes a fastener member having a planar element and having a cutting member for engaging into a plasterboard, and one or more teeth formed on the planar element, one or more reinforcing ribs extended from the planar element for reinforcing the planar element, and a head formed on top of the planar element for being engaged with driving tools and for limiting the engagement of the fastener member into the plasterboard. The planar element may include two longitudinal members secured together and having an identical shape. The head may include a board and two panels secured to the board for forming a two-layer structure.

### BACKGROUND OF THE INVENTION

1. Field of the Invention

The present invention relates to a plate-shaped fastener device, and more particularly to a plate-shaped fastener device for engaging with the plasterboards and for attaching or securing plasterboards together or for attaching or securing plasterboards to the other supporting objects or walls and for preventing the fastener device from being disengaged from the plasterboards and/or the supporting objects or walls.

2. Description of the Prior Art

Typical plasterboards have been developed and provided for building construction purposes, and the plasterboards are required to be secured together or required to be secured to the other supporting objects or walls with various kinds of fastener devices or fastener strips or the like.

For example, U.S. Pat. No. 4,121,715 to Hodil, Jr., and U.S. Pat. No. 5,713,709 to Huang disclose two of the typical fastener bands or belts comprising an elongated holding strop for holding or supporting a number of fasteners or nails.

When the plasterboards are fastened or secured together or secured to the other supporting objects or walls with such kinds of fasteners or nails, the fasteners or nails may have a good chance to be disengaged from the plasterboards and/or the supporting objects or walls, and the plasterboards may have a good chance to be broken by the fasteners or nails.

U.S. Pat. No. 6,196,506 to Wakai discloses another typical plate-shaped fastener for securing a member or instrument to a wall of plasterboard, and comprising a driving portion having a pointed tip. However, typical plate-shaped fasteners may not be driven or hammered with driving tools and may not be attached to or supported on a fastener band or belt.

The present invention has arisen to mitigate and/or obviate the afore-described disadvantages of the conventional fastener devices for plasterboards.

### SUMMARY OF THE INVENTION

The primary objective of the present invention is to provide a plate-shaped fastener device for engaging with the plasterboards and for attaching or securing plasterboards together or for attaching or securing plasterboards to the other supporting objects or walls and for preventing the fastener device from being disengaged from the plasterboards and/or the supporting objects or walls and for preventing the plasterboards from being broken by the fastener device.

The other objective of the present invention is to provide a plate-shaped fastener device including a reinforcing structure that may be easily and quickly manufactured.

In accordance with one aspect of the invention, there is provided a fastener device comprising a fastener member including a planar element having a cutting member provided on a lower portion thereof, and including a head provided on top of the planar element, and the planar element includes two longitudinal members secured together.

The longitudinal members include an identical shape. The head include a board and two panels secured to the board for forming a two-layer structure.

The board is an intermediate board, and the panels are extended from two sides of the intermediate board and folded and engaged with a bottom portion of the intermediate board and secured to the intermediate board. The longitudinal members are extended from the panels respectively.

The fastener member includes a plurality of teeth extended from side portions of the planar element for anchoring purposes. The teeth are preferably the ratchet teeth.

The fastener member includes at least one first reinforcing rib extended from the planar element for reinforcing the planar element. The fastener member includes at least one second reinforcing rib extended from the planar element for further reinforcing the planar element, and the second reinforcing rib is preferably extended opposite to the first reinforcing rib.

The fastener member includes at least one projection extended from the planar element and is preferably a ratchet projection. The head may include an upwardly curved structure, a downwardly curved structure, or a planar structure.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of one of the fastener members of a fastener device in accordance with the present invention;

FIG. 2 is another perspective view similar to FIG. 1 illustrating the other arrangement of the fastener member;

FIG. 3 is a further perspective view similar to FIGS. 1 and 2 illustrating the further arrangement of the fastener member;

FIG. 4 is a plan schematic view illustrating a planar member for manufacturing the fastener member;

FIG. 5 is a further perspective view similar to FIGS. 1-3 illustrating the still further arrangement of the fastener member;

FIG. 6 is a further perspective view similar to FIGS. 1-3 and 5 illustrating the still further arrangement of the fastener member;

FIG. 7 is a further perspective view similar to FIGS. 1-3 and 5-6 illustrating the still further arrangement of the fastener member;

FIG. 8 is a further perspective view similar to FIGS. 1-3 and 5-7 illustrating the still further arrangement of the fastener member;

FIG. 9 is a further perspective view similar to FIGS. 1-3 and 5-8 illustrating the still further arrangement of the fastener member;

FIG. 10 is a further perspective view similar to FIGS. 1-3 and 5-9 illustrating the still further arrangement of the fastener member;

FIG. 11 is a further perspective view similar to FIGS. 1-3 and 5-10 illustrating the still further arrangement of the fastener member;

FIG. 12 is a cross sectional view of the fastener member taken along lines 12-12 of FIG. 11;

FIG. 13 is a further perspective view similar to FIGS. 1-3 and 5-11 illustrating the still further arrangement of the fastener member;

FIG. 14 is a cross sectional view of the fastener member taken along lines 14-14 of FIG. 13;

FIG. 15 is a further perspective view similar to FIGS. 1-3 and 5-11 and 13 illustrating the still further arrangement of the fastener member; and

FIG. 16 is a side plan schematic view of the fastener member as shown in FIG. 15.

### DETAILED DESCRIPTION OF THE PREFERRED EMBODIMENT

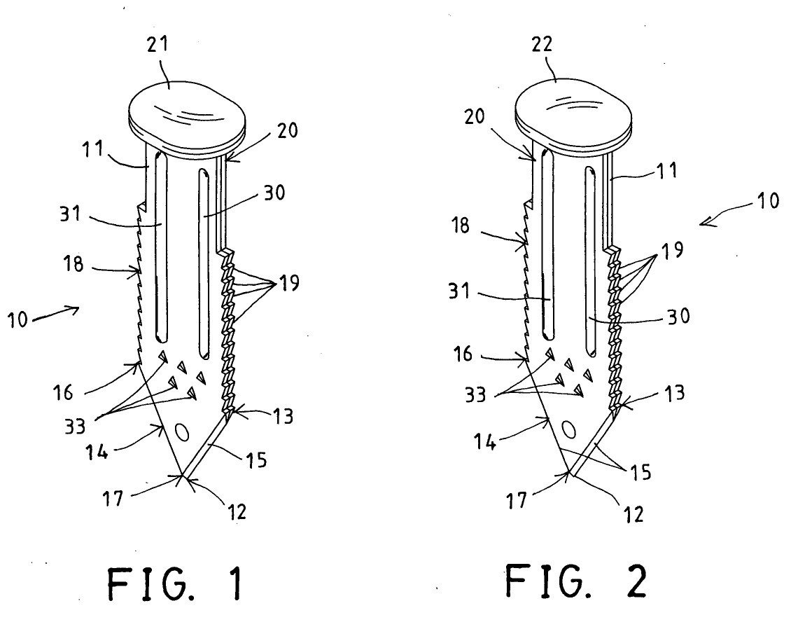

Referring to the drawings, and initially to FIGS. 1-3, a fastener device in accordance with the present invention comprises a number of fastener members 10 held or supported together with one or more holding or supporting strips (not shown). However, the attachment or the securing of the fastener members 10 to the holding or supporting strips is not related to the present invention and will not be described in further details. One example of the attachment or the securing of the fastener members 10 to the holding or supporting strips has been disclosed in the co-pending U.S. patent application Ser. No. 11/582,004, filed 17 Oct. 2006, which may be taken as a reference for the present invention.

As shown in FIGS. 1-3, the fastener members 10 each include a planar body or plate or element 11 having a tip 12 extended from the lower portion 13 thereof for easily engaging into one or more plasterboards (not shown) for attaching or securing the plasterboards together or for attaching or securing the plasterboards to the other supporting objects or walls (not shown), and for preventing the plasterboards from being broken by the fastener members 10 of the fastener device. The fastener members 10 each further include a cutting portion or member 14 formed or provided in the lower portion 13 thereof and located between the planar element 11 and the tip 12 of the fastener member 10.

The cutting member 14 includes one or more cutting edges 15 formed or provided therein for further facilitating the engagement of the fastener members 10 into the plasterboards, and for further preventing the plasterboards from being broken by the fastener members 10 of the fastener device. It is preferable that the cutting member 14 of the fastener member 10 includes a wider upper portion 16 adjacent or abutting the fastener member 10 or located closer to the fastener member 10, and includes a narrower lower portion 17 adjacent or abutting the tip 12 or located closer to the tip 12 for allowing the cutting member 14 of the fastener member 10 to be formed as a triangular shape or wedge-shape and for further facilitating the engagement of the fastener members 10 into or through the plasterboards.

The fastener member 10 further includes an anchoring means or device 18 formed or provided on the side portion thereof and having one or more teeth 19, such as ratchet teeth 19 provided on or extended from the side portion of the fastener member 10 for engaging with the plasterboards after the fastener member 10 has been engaged into or through the plasterboards, and thus for anchoring or securing the fastener member 10 to the plasterboards and for preventing the fastener member 10 from being disengaged from the plasterboards. The fastener member 10 further includes an upper portion 20 having a head 21, 22, 23 to the planar element 11 of the fastener member 10. The heads 21-23 are preferably arranged perpendicular to the planar element 11 of the fastener members 10 for engaging with the plasterboards and for limiting the movement or the engagement of the fastener members 10 into or through the plasterboards and for preventing the fastener member 10 from being completely engaged into or through the plasterboards.

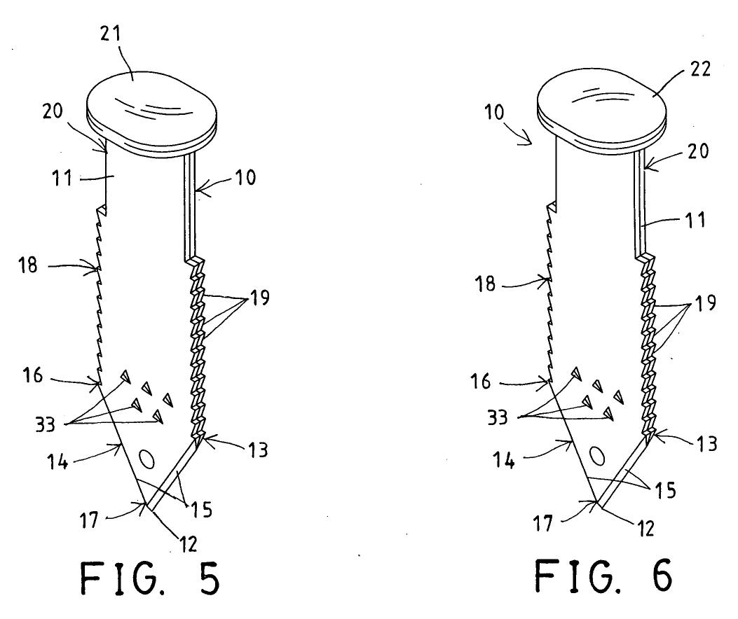

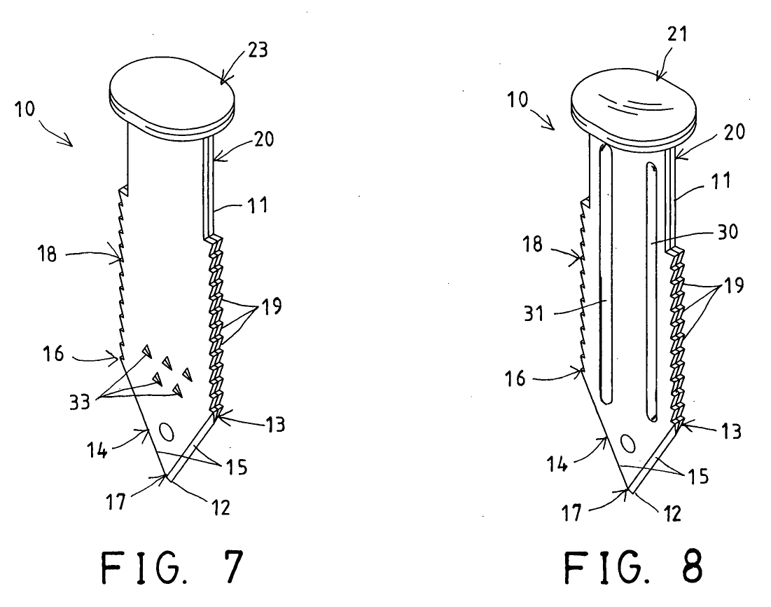

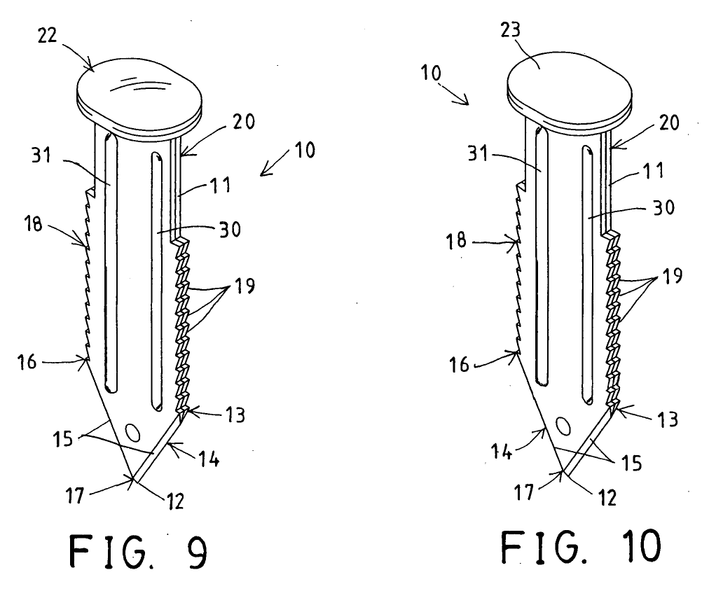

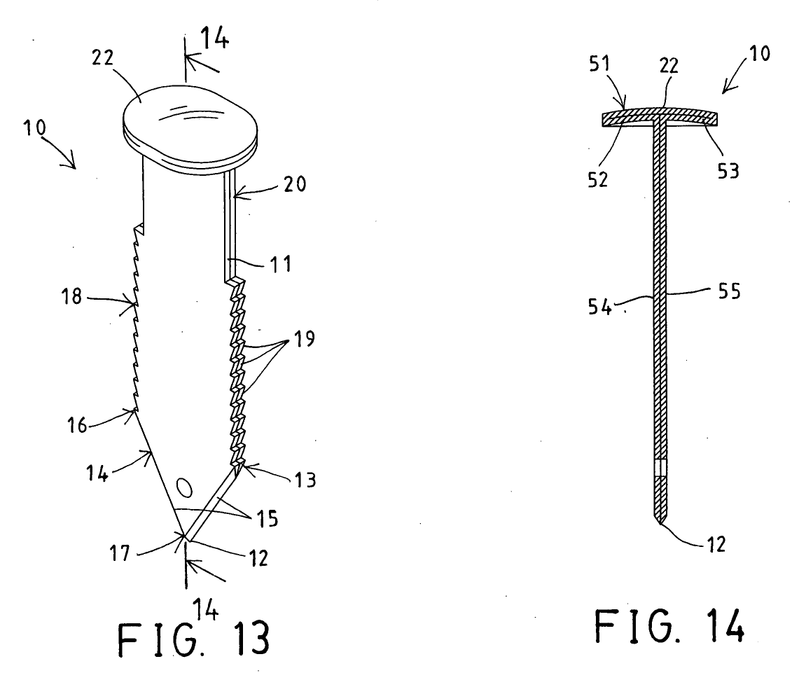

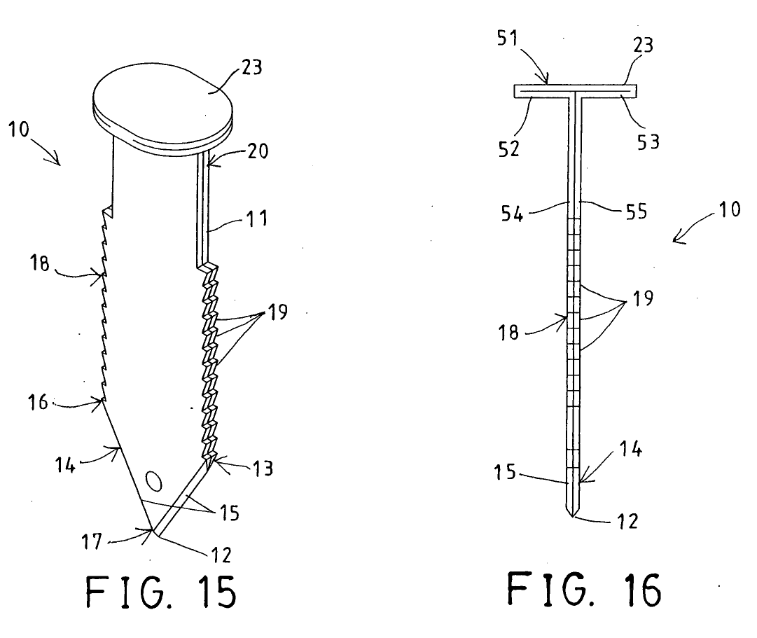

For example, the heads 21 of the fastener members 10 may include a recessed or downwardly curved structure (FIGS. 1, 5, 8, 11-12), or the head 22 may include an upwardly curved structure (FIGS. 2, 6, 9, 13-14), or the head 23 may include a flat or planar structure (FIGS. 3, 7, 10, 15-16), and the heads 21-23 are arranged for such as centering purposes, or for facilitating the driving or the engagement of the fastener members 10 into or through the plasterboards, or for allowing the fastener member 10 to be easily driven or hammered by the driving tools (not shown).

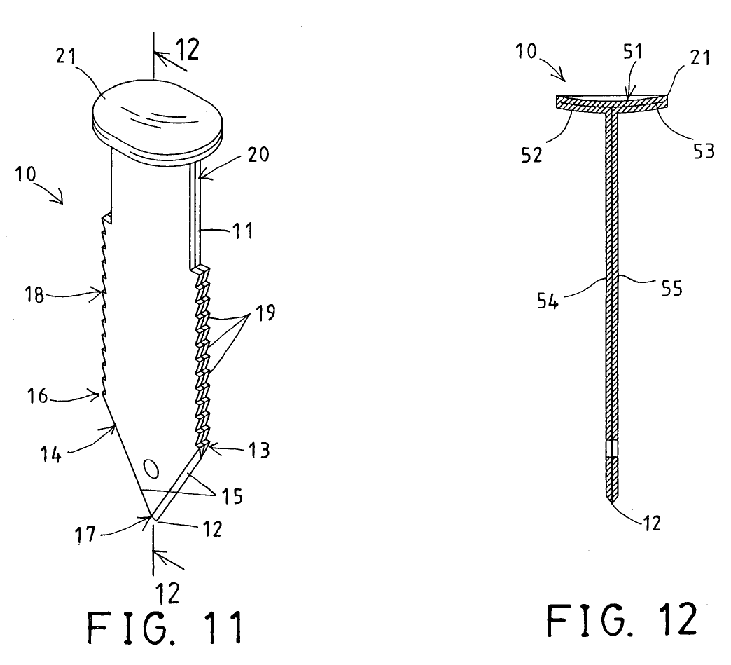

As shown in FIGS. 1-3, 8-10, the fastener member 10 may further include one or more reinforcing protrusions or ribs 30 extended from one side thereof for forming a recess in the other side or the opposite side thereof, and/or one or more further reinforcing protrusions or ribs 31 extended from the other side or the opposite side thereof for forming a recess in the one side thereof, and for reinforcing the fastener member 10 and for preventing the fastener member 10 from being easily bent or distorted, and also for allowing the fastener member 10 to be effectively driven or engaged into or through the plasterboards. As shown in FIGS. 1-3 and 5-7, the fastener member 10 each may further include one or more ratchet teeth or projections 33 extended from either of the sides of the planar element 11 for further engaging with the plasterboards and for further preventing the fastener member 10 from being disengaged from the plasterboards. The fastener member 10 may include no ribs 30, 31 and no projections 33 (FIGS. 11-16).

It is to be noted that the provision of the tip 12 and/or the cutting member 14 allows the fastener member 10 to be easily driven or hammered into or through the plasterboards by the driving tools and may prevent the plasterboards from being broken by the fastener device. The anchoring means or device 18 of the fastener member 10 may anchor or secure the fastener member 10 to the plasterboards and may prevent the fastener member 10 from being disengaged from the plasterboards. The reinforcing protrusions or ribs 30, 31 may prevent the fastener member 10 from being easily bent or distorted. The ratchet projections 33 of the fastener members 10 may further anchor or secure the fastener members 10 to the plasterboards and may prevent the fastener member 10 from being disengaged from the plasterboards. One example of the fastener members 10 has been disclosed and filed in the co-pending U.S. patent application Ser. No. 12/012,170, filed 30 Jan. 2008, which may be taken as a reference for the present invention.

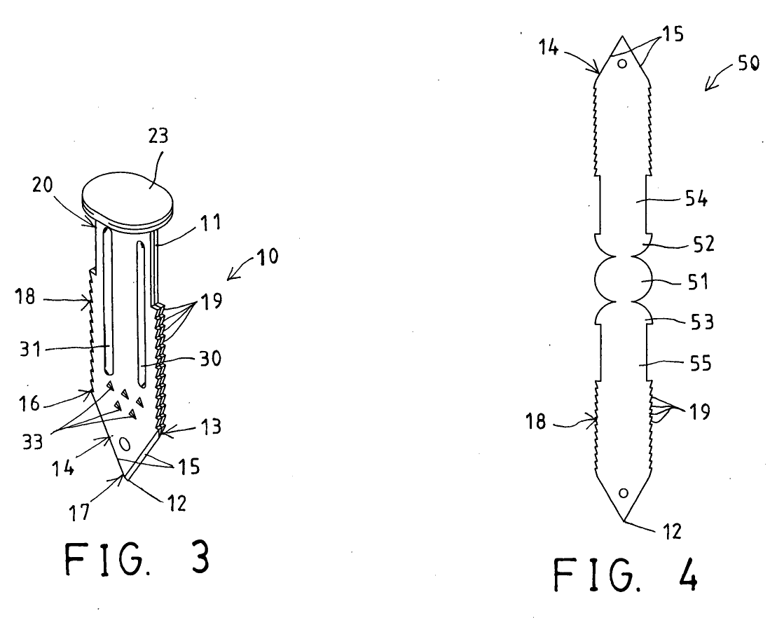

As shown in FIGS. 1, 4, 12, 14, 16, the fastener member 10 may be formed or made or manufactured from a planar member 50 which includes a middle or intermediate board 51 having a shape similar to or corresponding to that of the heads 21-23, two panels 52, 53 extended from or coupled to two sides of the intermediate board 51 and to be folded relative to the intermediate board 51 for engaging with the bottom portion of the intermediate board 51, and two longitudinal members 54, 55 extended from or coupled to the panels 52, 53 respectively and to be folded relative to each other and to be secured together with such as forging, beating, or hammering and/or adhering or welding procedures. The teeth 19 of the anchoring means or device 18 may be punched or formed in the planar member 50 when the planar member 50 is formed or made or manufactured or shaped.

The fastener element 10 may thus include two longitudinal members 54, 55 having the identical shape and secured together to form the planar element 11 of the fastener members 10, and may include an intermediate board 51 and two panels 52, 53 forged or hammered and secured together for forming a reinforcing structure, and the two panels 52, 53 each may include a shape corresponding to a portion of the intermediate board 51, such as one half of the intermediate board 51, and the two panels 52, 53 may be formed into the shape of the intermediate board 51 after the panels 52, 53 are folded relative to the intermediate board 51 and engaged with the bottom portion of the intermediate board 51 and secured to the bottom portion of the intermediate board 51 with the forging, beating, or hammering and/or adhering or welding procedures, for forming a two-layer structure.

It is to be noted that, while forging, beating, or hammering the planar member 50 into the fastener member 10, the recessed or downwardly curved structure or the upwardly curved structure or the flat or planar structure of the heads 21-23 and the ribs 30, 31 and the projections 33 and/or the cutting edges 15 of the cutting member 14 may be formed or made or manufactured or shaped simultaneously, and the heads 21-23 may be directly formed and shaped on top of the planar element 11 of the fastener members 10 without additional assembling procedures, the planar element 11 may include two longitudinal members 54, 55 directly forged or hammered and secured together for increasing the strength of the planar element 11 of the fastener members 10. The cutting edges 15 of the cutting member 14 may also be formed or made or manufactured or shaped after the intermediate board 51 and the panels 52, 53 and the longitudinal members 54, 55 have been folded and formed into the fastener members 10.

Accordingly, the fastener device in accordance with the present invention includes a plate-shaped fastener device for engaging with the plasterboards and for attaching or securing plasterboards together or for attaching or securing plasterboards to the other supporting objects or walls and for preventing the fastener device from being disengaged from the plasterboards and/or the supporting objects or walls and for preventing the plasterboards from being broken by the fastener device, and includes a reinforcing structure that may be easily and quickly manufactured.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A fastener device comprising:
a fastener member including a planar element having a cutting member provided on a lower portion thereof, and including a head provided on top of said planar element, and
said planar element including two longitudinal members secured together.

2. The fastener device as claimed in claim 1, wherein said longitudinal members include an identical shape.

3. The fastener device as claimed in claim 1, wherein said head include a board and two panels secured to said board for forming a two-layer structure.

4. The fastener device as claimed in claim 3, wherein said board is an intermediate board, and said panels are extended from two sides of said intermediate board and folded relative to said intermediate board and engaged with a bottom portion of said intermediate board and secured to said intermediate board.

5. The fastener device as claimed in claim 3, wherein said panels each include a shape corresponding to one half of said intermediate board.

6. The fastener device as claimed in claim 3, wherein said longitudinal members are extended from said panels respectively.

7. The fastener device as claimed in claim 1, wherein said fastener member includes a plurality of teeth extended from side portions of said planar element for anchoring purposes.

8. The fastener device as claimed in claim 7, wherein said teeth are ratchet teeth.

9. The fastener device as claimed in claim 1, wherein said fastener member includes at least one first reinforcing rib extended from said planar element for reinforcing said planar element.

10. The fastener device as claimed in claim 9, wherein said fastener member includes at least one second reinforcing rib extended from said planar element for further reinforcing said planar element.

11. The fastener device as claimed in claim 10, wherein said at least one second reinforcing rib is extended opposite to said at least one first reinforcing rib.

12. The fastener device as claimed in claim 1, wherein said fastener member includes at least one projection extended from said planar element.

13. The fastener device as claimed in claim 12, wherein said at least one projection of said planar element is a ratchet projection.

14. The fastener device as claimed in claim 1, wherein said head includes an upwardly curved structure.

15. The fastener device as claimed in claim 1, wherein said head includes a downwardly curved structure.

16. The fastener device as claimed in claim 1, wherein said head includes a planar structure.
